(19) United States
(12) Patent Application Publication
(10) Pub. No.: US 2007/0153240 A1
(43) Pub. Date: Jul. 5, 2007

(54) PROJECTOR AND INTEGRATION ROD THEREOF

(75) Inventors: Chin Ku Liu, Mao Li County (TW); Chien Chung Liao, Mao Li County (TW)

Correspondence Address: LOWE HAUPTMAN BERNER, LLP, 1700 DIAGONAL ROAD, SUITE 300, ALEXANDRIA, VA, 22314, US

(73) Assignee: CORETRONIC CORPORATION, MAO LI COUNTY (TW)

(21) Appl. No.: 11/558,820

(22) Filed: Nov. 10, 2006

(30) Foreign Application Priority Data
Dec. 29, 2005 (TW) 094147242

(51) Int. Cl. G03B 21/28

(52) U.S. Cl. 353/98

(57) ABSTRACT

A projector and the integration rod thereof are disclosed. The integration rod includes an entrance face, an exit face and a side face extending from the rim of the entrance face and reaching the rim of the exit face. The normal line through the geometric center of the entrance face does not coincide with that through the geometric center of the exit face whereby compensating a non-uniformity image resulting from the projector design factors, and therefore improving the uniformity of the image projected on a screen.

This application claims the priority benefit of Taiwan Patent Application Serial Number 094147242 filed Dec. 29, 2005, the full disclosure of which is incorporated herein by reference.

### BACKGROUND OF THE INVENTION

1. Field of the Invention

The invention relates to a projector, and more particularly, to an integration rod for a projector.

2. Description of the Related Art

Referring to FIG. 1, it illustrates the optical system 100 of a conventional digital light processing (DLP) projector. A reflector 104 collects a light beam emitted from a light source 102 and directs the collected light beam to a color wheel 106. The light beam is filtered through the color wheel 106 and then incident upon an integration rod 108. The integration rod 108 homogenizes the light beam and outputs the homogenized light beam to a relay lens 110. The relay lens 110 is used to relay the homogenized light beam from the integration rod 108 to a digital micro-mirror device (DMD) 112. The DMD 112 selectively reflects the light beam to transform it to an image light beam. The image light beam passes through a projection lens 114 and is projected onto a screen 116 to form the desired image.

In general, the integration rod 108 is typically classified into a solid integration rod (as shown in FIG. 2a) and a hollow integration rod (as shown in FIG. 2b). The integration rod 108 has an entrance face 120 at one end and an exit face 130 at the other end. The cross section of the integration rod 108 becomes gradually large from the entrance face 120 toward the exit face 130 and the normal lines through the geometric centers of the two faces 120, 130 coincide with each other (See FIG. 2c). The light beam enters the integration rod 108 from the entrance face 120 and is being homogenized via multiple reflections off the side faces of the integration rod 108 so that the emitted light is nominally uniform at the exit face 130.

While the light emitted from the integration rod 108 is uniform, an optical system provided with the integration rod 108 does not always output a uniform image on a screen. For example, a low offset projector with 100% to 110% offset using a non-telecentric illumination system is likely to have an undue truncation of relay lens so that the image projected by the offset projector on a screen is darker on the lower-left corner. The image projected by a high offset projector with 110% to 140% offset is darker on the area away from the optical axis of the projection lens, i.e. on the upper-left corner and upper-right corner of the image, resulting from the physical limitation of the projection lens.

In view of the above, there exists a need for an integration rod of a projector which overcomes the above-mentioned problem of non-uniform image on a screen in the prior art.

### SUMMARY OF THE INVENTION

It is an object of the present invention to provide a projector and the integration rod thereof that solves a non-uniformity image on a screen resulting from the projector design factors and therefore improves the uniformity of the image projected on a screen.

In one embodiment, an integration rod of the present invention includes an entrance face, an exit face and a side face extending from the rim of the entrance face and reaching the rim of the exit face. The normal line through the geometric center of the entrance face does not coincide with the normal line through the geometric center of the exit face whereby compensating a non-uniformity image projected on a screen resulting from the projector design factors, and therefore improving the uniformity of the image projected on a screen.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram showing an optical system of a conventional projector.

FIG. 2a is a perspective view of a conventional solid integration rod.

FIG. 2b is a perspective view of a conventional hollow integration rod.

FIG. 2c is a front view of a conventional solid integration rod.

FIG. 3a is a front view of an integration rod according to an embodiment of the present invention.

FIG. 3b is a side view of an integration rod according to the embodiment of the present invention.

FIG. 4 is a diagram showing the energy distribution of the emitted light at the exit face of the integration rod according to the embodiment of the present invention.

FIG. 5 is a diagram showing the energy distribution of the emitted light at the exit face of the conventional integration rod.

FIG. 6 is a diagram showing the energy distribution projected onto a screen for a projector adopting the integration rod of the present invention.

FIG. 7 is a diagram showing the energy distribution projected onto a screen for a projector adopting the conventional integration rod.

FIG. 8 is a perspective view of an integration rod according to another embodiment of the present invention.

FIGS. 9a to 9k are front views of the integration rods according to other embodiments of the present invention.

FIG. 10 is a schematic diagram showing the optical system of the projector according to the present invention.

### DETAILED DESCRIPTION OF THE PREFERRED EMBODIMENT

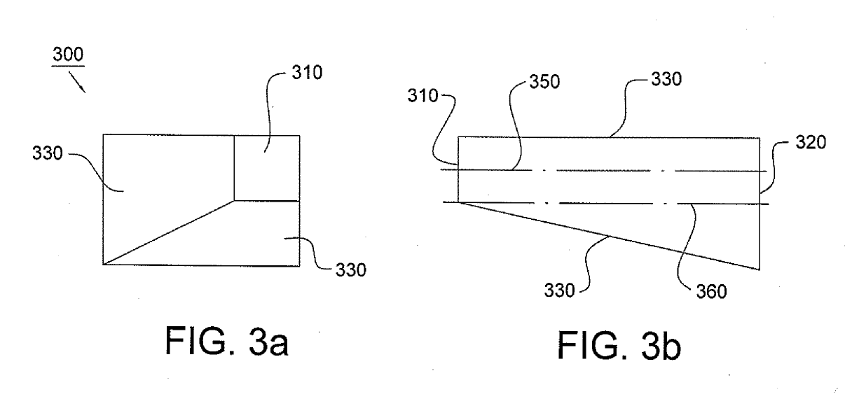

Referring now to FIGS. 3a and 3b, an asymmetric integration rod 300 according to an embodiment of the present invention includes an entrance face 310, an exit face 320 and a side face 330 extending from the rim of the entrance face 310 to the rim of the exit face 320. The entrance and exit faces 310, 320 are formed as quadrangles respectively. In this embodiment, the entrance face 310 is in a shape of a square and the exit face 320 is in a shape of a rectangle. The normal line 350 through the geometric center of the entrance face 310 does not coincide with the normal line 360 through the geometric center of the exit face 320. In addition, in this embodiment, the orthogonal projection of the entrance face 310 onto the plane of the exit face 320 is totally on the exit face 320. The orthogonal projection of the entrance face 310 is on the right-upper corner of the exit face 320 and two adjacent sides thereof align with two adjacent sides of the exit face 320. The light beam incident into the integration rod 300 from the entrance face 310 is reflected on the side face 330 many times to uniform the light beam and then transmits the uniform light beam out of the integration rod 300 from the exit face 320.

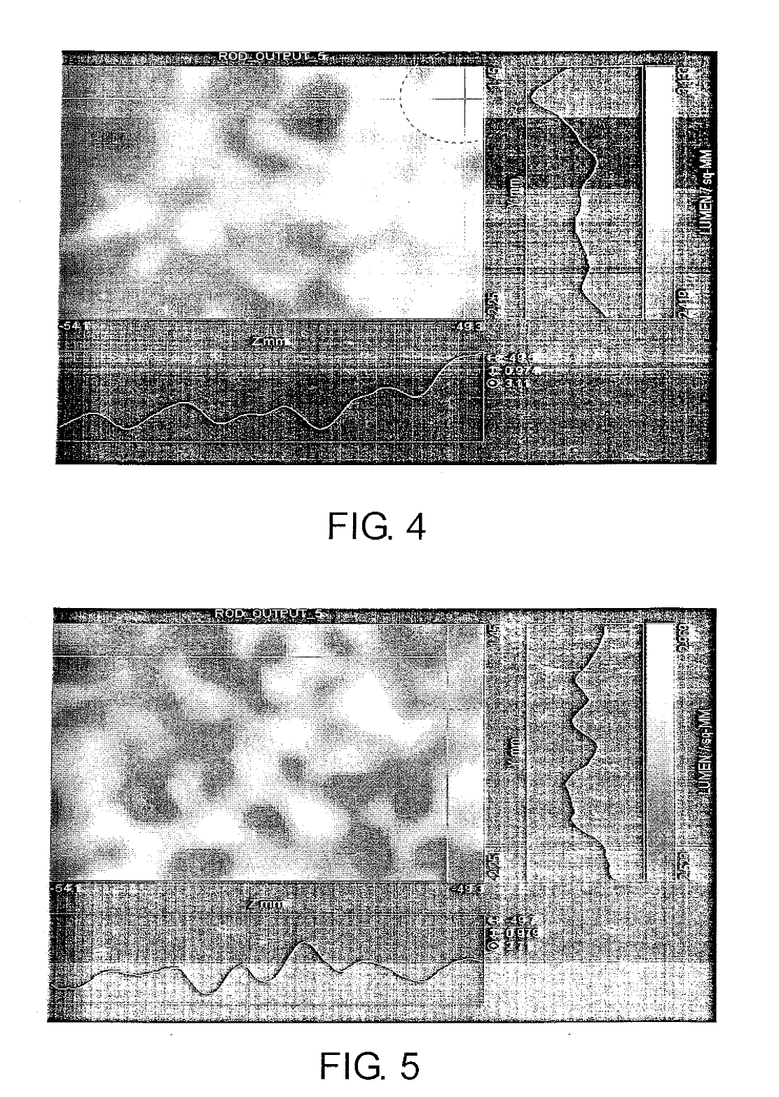

Referring now to FIG. 4, it shows the energy distribution of the emitted light at the exit face 320 when the light beam is incident into the integration rod 300 from the entrance face 310 and transmitted out from the exit face 320. The energy density of the emitted light at the exit face 320 has a highest corner on the upper-right corner. Because the orthogonal projection of the entrance face 310 onto the plane of the exit face 320 is on the upper-right corner of the exit face 320. Referring to FIG. 5, it shows the energy distribution of the emitted light at the exit face 130 when the light beam is incident into the conventional symmetric integration rod 108 from the entrance face 120 and emitted from the exit face 130. As shown in the FIGS. 4 and 5, the energy distribution of the light emitted from the integration rod 108 at the exit face 130 is more uniform.

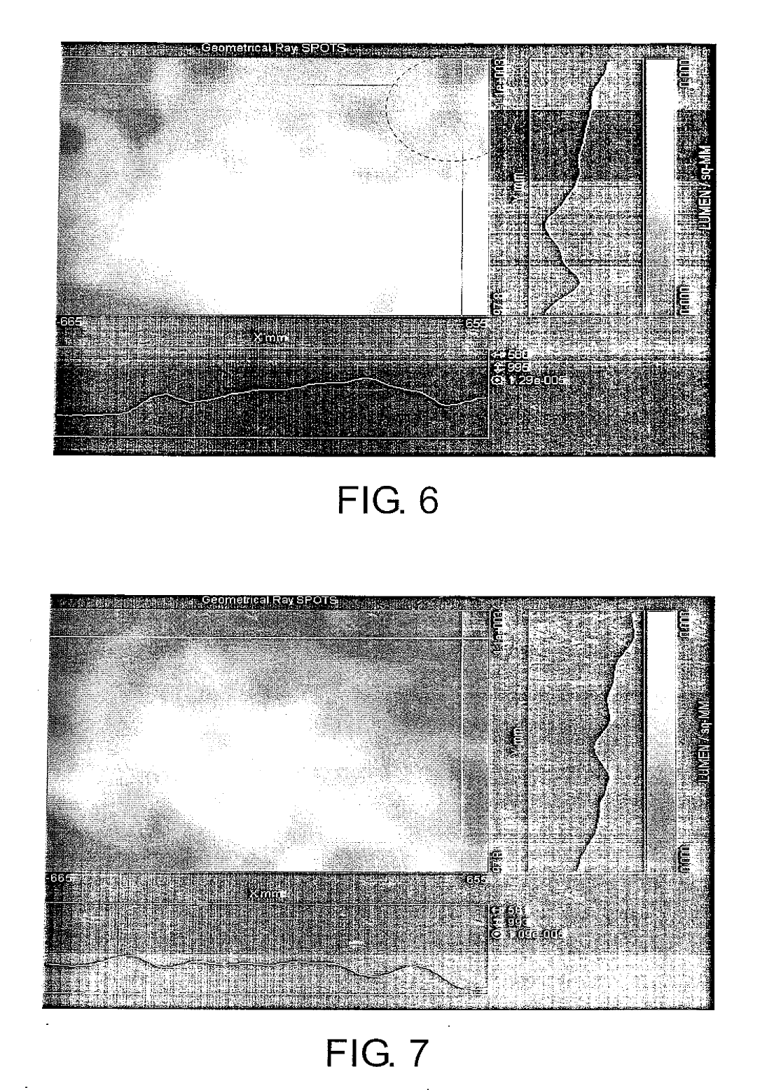

Referring now to FIGS. 6 and 7, the energy distribution projected onto a screen is provided from the projectors with 110% offset using non-telecentric illumination systems that adopt the asymmetric integration rod 300 according to the embodiment of the present invention and the conventional symmetric integration rod 108 respectively. The image projected from the projector incorporating the conventional symmetric integration rod 108 is darker on the upper-right corner of the screen (See FIG. 7). However, an image projected from the projector incorporating the integration rod 300 according to the embodiment of the present invention exhibits an enhanced brightness on the upper-right corner of the screen and therefore the image has better uniformity (See FIG. 6). Based on the result of simulation, the projector using the conventional symmetric integration rod 108 exhibits the ANSI uniformity in 40 percent. The projector using the asymmetric integration rod 300 according to the present invention exhibits the ANSI uniformity in 52 percent. The uniformity of the projector has increased of 12 percent by using the integration rod 300. Accordingly, the projector using the asymmetric integration rod 300 increases the uniformity of the image projected on a screen.

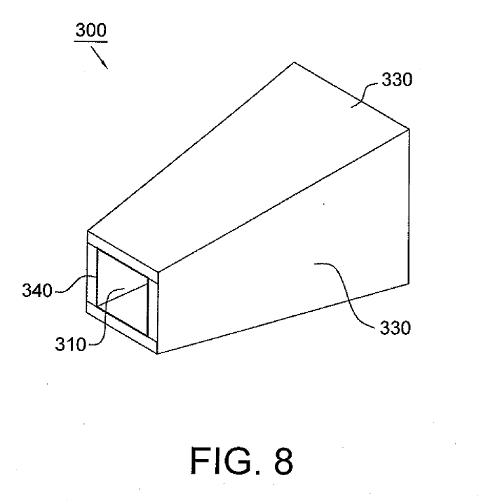

The integration rod 300 of the present invention is a solid transparent body. Besides, referring to FIG. 8, in the embodiment, the integration rod 300 is a hollow body. The entrance face 310 and exit face 320 are openings of the hollow body, and the inner surface of the side face 330 is coated with a reflection layer 340 thereon. The light beam incident into the integration rod 300 is reflected on the reflection layer 340 many times to uniform the light beam.

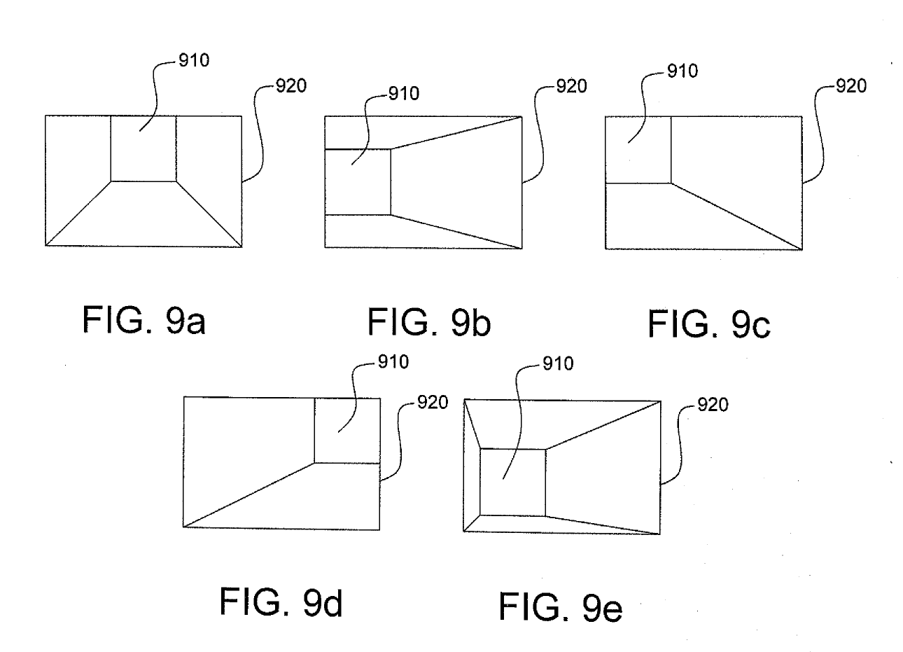

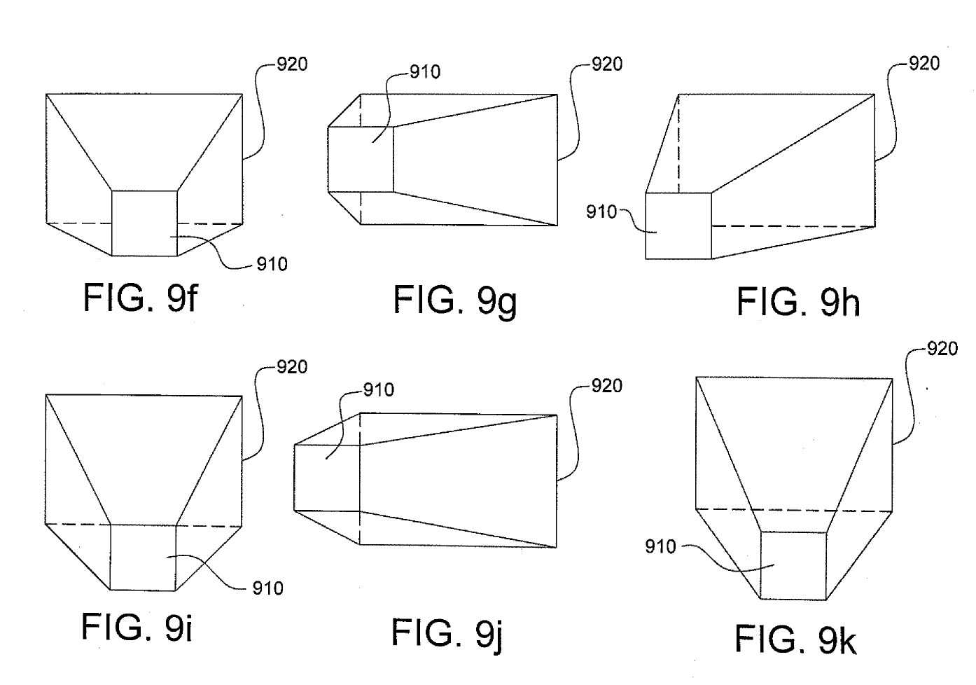

Referring to FIGS. 9a to 9k, they show asymmetric integration rods 900 according to other embodiments of the present invention. The configurations of the integration rods 900 are similar to that of the integration rod 300. Each of the integration rods 900 also has two opposing entrance and exit faces 910, 920, and the normal lines through the geometric centers of the entrance and exit faces 910, 920 do not coincide with each other. Referring to FIGS. 9a to 9e, the orthogonal projections of the entrance faces 910 onto the planes of the exit faces 920 are totally on the exit faces 920. The relationships between the orthogonal projections and the exit faces 920 are further classified as follows: (i) as shown in FIG. 9a, one side of the orthogonal projection aligns with the longest side of the exit face 920; (ii) as shown in FIG. 9b, one side of the orthogonal projection aligns with the shortest side of the exit face 920; (iii) as shown in FIGS. 9c and 9d, two adjacent sides of the orthogonal projection align with two adjacent sides of the exit face 920; and (iv) as shown in FIG. 9e, none of the sides of the orthogonal projection intersects with the sides of the exit face 920.

Referring to FIGS. 9f to 9h, the orthogonal projections of the entrance faces 910 onto the planes of the exit faces 920 are partially on the exit faces 920. The relationships between the orthogonal projections and the exit faces 920 are further classified as follows: (i) as shown in FIG. 9f, two opposing sides of the orthogonal projection intersect with the longest side of the exit face 920; (ii) as shown in FIG. 9g, two opposing sides of the orthogonal projection intersect with the shortest side of the exit face 920; and (iii) as shown in FIG. 9h, two adjacent sides of the orthogonal projection intersect with two adjacent sides of the exit face 920.

Referring to FIGS. 9i to 9k, the orthogonal projections of the entrance faces 910 onto the planes of the exit faces 920 are out of the exit faces 920. The relationships between the orthogonal projections and the exit faces 920 are further classified as follows: (i) as shown in FIG. 9i, one side of the orthogonal projection aligns with the longest side of the exit face 920; (ii) as shown in FIG. 9j, one side of the orthogonal projection aligns with the shortest side of the exit face 920; and (iii) as shown in FIG. 9k, none of the sides of the orthogonal projection intersects with the sides of the exit face 920.

The above-mentioned asymmetric integration rods 900 are used in projectors for solving a non-uniformity image on a screen resulting from the projector design factors and therefore improving the uniformity of the image projected on a screen.

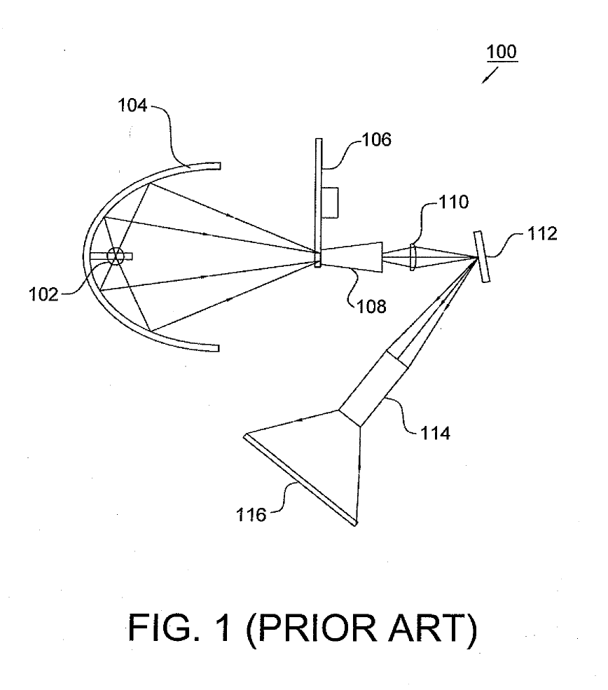

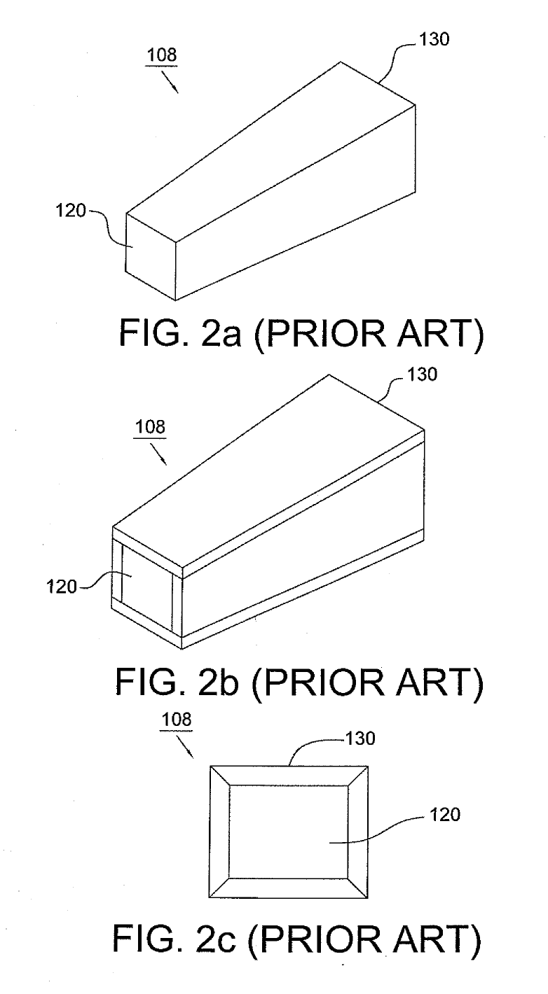

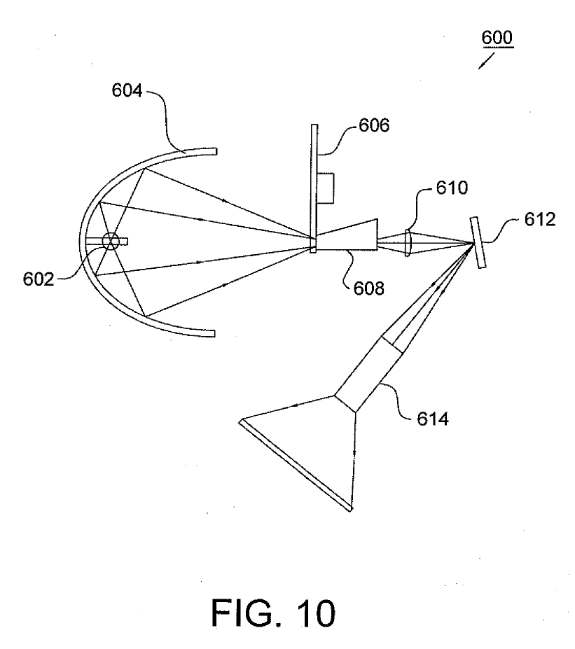

In addition, the integration rods of the present invention are used in projectors. For example, referring to FIG. 10, an optical system 600 of a projector includes a light source 602 for emitting a light beam, a reflector 604, a color wheel 606, an integration rod 608 arranged in an optical path of the light beam for homogenizing the light beam, a relay lens 610, a light valve 612 such as a DMD arranged in the optical path of the light beam for transforming the light beam into an image light beam, and a projection lens 614 arranged in the optical path of the image light beam. The configuration of the optical system 600 is similar to that of the optical system 100 in FIG. 1. Thus, any further illustrations of the optical system 600 are omitted herein. In contrast to the optical system 100, the optical system 600 of the present invention adopts the integration rods 300 or 900 as the integration rod 608 so as to improve the poor uniformity of the optical system 100. Furthermore, in this embodiment, the projector is an offset projector using a non-telecentric illumination system, which is constituted by the optical source 602 and integration rod 608.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A projector, comprising
a light source for emitting a light beam;
an integration rod arranged in an optical path of the light beam for homogenizing the light beam, the integration rod comprising an entrance face, an exit face and a side face extending from the rim of the entrance face to the rim of the exit face, the normal line through the geometric center of the entrance face not coinciding with the normal line through the geometric center of the exit face;
a light valve arranged in the optical path of the light beam for transforming the light beam into an image light beam; and
a projection lens arranged in an optical path of the image light beam.

2. The projector as claimed in claim 1, wherein the orthogonal projection of the entrance face onto the plane of the exit face is totally on the exit face.

3. The projector as claimed in claim 1, wherein the orthogonal projection of the entrance face onto the plane of the exit face is partially on the exit face.

4. The projector as claimed in claim 1, wherein the orthogonal projection of the entrance face onto the plane of the exit face is out of the exit face.

5. The projector as claimed in claim 1, wherein the integration rod is a solid transparent body.

6. The projector as claimed in claim 1, wherein the integration rod is a hollow body, the entrance face and exit face are openings of the hollow body, the inner surface of the side face is disposed with a reflection layer thereon.

7. The projector as claimed in claim 1, wherein the projector is an offset projector using a non-telecentric illumination system, the illumination is constituted by the optical source and the integration rod.

8. An integration rod, comprising:
an entrance face;
an exit face; and
a side face extending form the rim of the entrance face to the rim of the exit face, the normal line through the geometric center of the entrance face not coinciding with the normal line through the geometric center of the exit face.

9. The integration rod as claimed in claim 8, wherein the integration rod is a solid transparent body.

10. The integration rod as claimed in claim 8, wherein the integration rod is a hollow body, the entrance face and exit face are openings of the hollow body, the inner surface of the side face is disposed with a reflection layer thereon.

11. The integration rod as claimed in claim 8, wherein the orthogonal projection of the entrance face onto the plane of the exit face is totally on the exit face.

12. The integration rod as claimed in claim 8, wherein the orthogonal projection of the entrance face onto the plane of the exit face is partially on the exit face.

13. The integration rod as claimed in claim 8, wherein the orthogonal projection of the entrance face onto the plane of the exit face is out of the exit face.

14. The integration rod as claimed in claim 8, wherein the entrance face and exit face are formed as quadrangles respectively.
